(19) United States
(12) Patent Application Publication
(10) Pub. No.: US 2005/0272336 A1
(43) Pub. Date: Dec. 8, 2005

(54) Polymer compositions with antimicrobial properties

(76) Inventors: Jing C. Chang, Boothwyn, PA (US); Gyorgyi Fenyvesi, Wilmington, DE (US); Joseph V. Kurian, Hockessin, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/861,943

(22) Filed: Jun. 4, 2004

(51) Int. Cl. A01N 25/34; B32B 5/02; D02G 3/00; D04H 13/00; D04H 5/00; D04H 3/00; D04H 1/00; B32B 27/04; B32B 27/12

(52) U.S. Cl. 442/123; 428/373; 424/404

(57) ABSTRACT

One aspect of the invention is to provide an antimicrobial composition comprising a polymer and an effective amount of polymeric additive. Another aspect of the invention is to provide a process for producing an antimicrobial polymer composition comprising incorporating into a polymer composition an effective amount of polymeric additive.

### FIELD OF THE INVENTION

This invention relates to the field of polymer compositions, preferably polyesters, having nonleachable antimicrobial properties, and suitable for use in manufacturing fibers, fabrics, films, and other useful articles. Specifically, it relates to the articles and methods of making such compositions, and in particular to articles suitable for apparel, flooring, and non-woven fabrics.

### BACKGROUND OF THE INVENTION

With recent advancements in medical knowledge, there is an increased awareness of the need for utilizing all possible measures to protect health. Such measures may include a need for apparel, carpeting, and other materials that help protect against infection from pathogenic agents such as bacteria. This is particularly the case in hospitals and other health care facilities, where cross-transmission of diseases and controlling postoperative infections are daily concerns. Of special importance are the non-woven gowns and other apparel for doctors, nurses, and patients. Microbial problems associated with wovens and nonwovens can be found in all segments of the textile industry. Proper control of microbial levels is important to the safety and market acceptance of the finished product.

There are primarily two major classifications of antimicrobial agents available to the market, nonleachable and leachable antimicrobial agents. Leachable antimicrobial agents, as opposed to nonleachables, are not chemically bonded with the fiber/fabric shaped polymeric items and non-woven fibers and can be removed by contact with moisture.

Commonly assigned U.S. Pat. No. 6,576,340 issued to Sun et al. on Jun. 10, 2003, and commonly assigned U.S. Pat. No. 6,723,799 issued to Sun et al. on Apr. 20, 2004, disclose acid-dyeable polyester and polymer compositions comprising a polymeric addivitve, wherein said compositions are suitable for use in manufacturing fibers, fabrics, films, and other useful articles, the articles, and methods of making such compositions and articles.

Very small amounts of the polymeric additive are needed when it is desired to make minor corrections to the dye depth achieved by the polymer. In such instances the compositions can contain as little as about 6 moles tertiary amine per million grams of the resulting polymer (“mpmg”). Minor corrections are effective for nylon polymers, which are generally dyed more easily than polyesters because of their greater permeability and, in the case of the preferred acid dyes, because the amine end groups in nylon serve as dyesites.

On the other hand, polyesters, especially polyester fibers and fabrics, are difficult to dye. The molecular structure and the high levels of orientation and crystallinity that impart the desirable properties to the polyester also contribute to a resistance to coloration by dye compounds. Also contributing to the difficulty in dyeing polyester compositions is the characteristic that polyesters do not have dye sites within the polymer chain that are reactive to basic or acid dye compounds. Effective dye depth for difficult to dye polymers requires much more than 6 mpmg.

### SUMMARY OF THE INVENTION

One aspect of this invention is to provide an antimicrobial polymer composition comprising:
a) a polymer composition comprising at least one polyester, at least one polyether, at least one polycarbonate, at least one polyolefin, or combinations thereof; and
b) about 0.1 to less than 2.0 mol % of a polymeric additive comprising repeating units having the formula 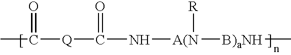
or salts thereof, wherein A, B, and Q, independently, are aliphatic or aromatic substituents provided that at least four carbon atoms separate any two nitrogen groups, R is an aliphatic or aromatic group or hydrogen, a is 1 to about 5, and n is 3 to about 10,000;
and wherein the nitrogen groups remain available for interaction with negatively charged functionalities.

Preferably, the polymer composition comprises a polyester, more preferably a polyalkylene terephthalate, and even more preferably polytrimethylene terephthalate. Preferably, the polymeric additive is poly(6,6′-alkylimino-bishexamethylene adipamide), poly(6,6′-alkylimino-bistetramethylene adipamide), poly(N,N′-dialkylimino-tri(tetramethylene)) adipamide, or combinations thereof, wherein the alkyl group has 1 to about 4 carbon atoms.

Another aspect of the invention is to provide a process for producing an antimicrobial polymer composition comprising incorporating into a polymer composition comprising at least one polyester, at least one polyether, at least one polycarbonate, at least one polyolefin, or combinations thereof an effective amount of polymeric additive comprising repeating units having the formula 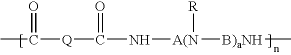
or salts thereof, wherein A, B, and Q, independently, are aliphatic or aromatic substituents provided that at least four carbon atoms separate any two nitrogen groups, R is an aliphatic or aromatic group or hydrogen, a is 1 to about 5, and n is 3 to about 10,000, and wherein the nitrogen groups remain available for interaction with negatively charged functionalities.

Another object is to provide a process for producing a dyed article comprising:
(a) providing an article;
(b) incorporating into the article an antimicrobial polymer composition comprising a polymer composition comprising at least one polyester, at least one polyether, at least one polycarbonate, at least one polyolefin, or combinations thereof; and an effective amount of polymeric additive comprising repeating units having the formula 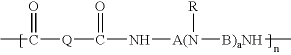
or salts thereof, wherein A, B, and Q, independently, are aliphatic or aromatic substituents provided that at least four carbon atoms separate any two nitrogen groups, R is an aliphatic or aromatic group or hydrogen, a is 1 to about 5, and n is 3 to about 10,000; and
(c) dyeing the article of produced by step (b) such that the nitrogen groups remain available for interaction with negatively charged functionalities.

Other objects and advantages of the present invention will become apparent to those skilled in the art upon reference to the detailed description that hereinafter follows.

### DETAILED DESCRIPTION OF THE INVENTION

Applicants specifically incorporate the entire content of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

In the context of this disclosure, a number of terms shall be utilized.

By “microorganism” is meant a living thing of microscopic or ultramicroscopic size that has, or can develop, the ability to act or function independently. Microorganisms include, for example, bacteria, fungi, viruses, protozoans, yeasts, and algae.

By “antimicrobial” is meant an agent capable of destroying, inhibiting the growth of, or preventing the growth of microorganisms. As used herein, antimicrobial includes, but is not limited to, antibacterials, that is, agents capable of destroying, inhibiting the growth of, or preventing the growth of bacteria; and antifungals, that is, agents capable of destroying, inhibiting the growth of, or preventing the growth of fungi. By “antimicrobial properties” is meant that, when a polymer composition incorporated with an effective amount of polymeric additive as described herein is in contact with microorganism-containing broth for a specific period of time, there is an exponential reduction of the starting microorganism population.

Reference to a polymer composition should be understood to mean a single polymer or blends or mixtures of such a polymer, blends or mixtures of different polymers, blends or mixtures of a single polymer having different molecular weights, or blends or mixtures of different polymers having different molecular weights. In other words, “polyester” means one or more polyesters. Thus, for instance, if applicant refers to a composition containing X mol % of a polyester, the composition may comprise X mol % of one polyester or X mol % total of different polyesters. Similarly, “polymeric additive” means one or more polymeric additives.

One aspect of the invention relates to a dyed article comprising:
a) a polymer composition comprising at least one polyester, at least one polyether, at least one polycarbonate, at least one polyolefin, or combinations thereof; and
b) about 0.1 to less than 2.0 mol % of a polymeric additive comprising repeating units having the formula 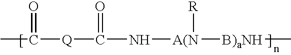
or salts thereof, wherein A, B, and Q, independently, are aliphatic or aromatic substituents provided that at least four carbon atoms separate any two nitrogen groups, R is an aliphatic or aromatic group or hydrogen, a is 1 to about 5, and n is 3 to about 10,000;
and wherein the nitrogen groups remain available for interaction with negatively charged functionalities.

Preferably, the polymeric additive is incorporated into the polymer composition before extrusion of the antimicrobial polymer composition. The polymer composition is preferably a polyester, more preferably a polyalkylene terephthalate, and more preferably still polytrimethylene terephthalate.

Another aspect of the invention is a process for producing an antimicrobial polymer composition comprising incorporating into a polymer composition comprising at least one polyester, at least one polyether, at least one polycarbonate, at least one polyolefin, or combinations thereof an effective amount of polymeric additive comprising repeating units having the formula 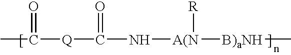
or salts thereof, wherein A, B, and Q, independently, are aliphatic or aromatic substituents provided that at least four carbon atoms separate any two nitrogen groups, R is an aliphatic (preferably non-cyclic alkyl) or aromatic group (preferably aryl) or hydrogen, a is 1 to about 5, and n is 3 to about 10,000, and wherein the nitrogen groups remain available for interaction with negatively charged functionalities. For the most part, the tertiary amine group will interact with negatively charged functionalities. Even in a mild acidic environment, the tertiary amine group can be easily protonated and can interact with the negatively charged bacteria cell wall, for example.

It should be understood that the polymeric additive can be polymer consisting essentially of or consisting of the repeating units shown above. Alternatively, it can be a polymer containing polymeric additive units and other polymeric units. Both types of polymeric additives are present in many instances, since, when heated, most of the polymeric additive will react with polymer or polymer forming compounds to form a new polymeric additive (polymer), while some of the initial polymeric additive remains unreacted. For instance, the composition prior to heating may comprise polyester and polymeric additive, and after heating such a composition may form a combination of polyester, block polymer of reacted polyester and polymeric additive, and unreacted polymeric additive.

Preferably n is from 3 to about 1,000, more preferably from 3 to about 100, and even more preferably from 3 to about 20.

The number of tertiary amines, represented by 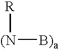
unit in the formula above, may vary from repeating unit to repeating unit and, therefore, a is an average. Preferably a is 1 or 2, more preferably 1.

When R is an aliphatic or aromatic group, it is inclusive of hetero atoms such as nitrogen or oxygen, i.e., it may be substituted or unsubstituted. It is preferably an alkyl group of 1 to 8 carbon atoms. The end groups of the polymeric additive may be hydrogen or hydroxide.

Preferably A, B, and Q, independently, are alkylene containing from 1 to 20 carbons or arylene substituents containing from 6 to 18 carbons, provided that A or B each contains either an alkylene unit containing at least 4 carbons or an arylene unit containing at least 6 carbons, and provided that Q contains either an alkylene unit containing at least 2 carbons or an arylene unit containing at least 6 carbons. The alkylene and arylene units may be substituted or unsubstituted, straight or branched, etc., as long as the substituents and branches do not substantially interfere with the antimicrobial properties (e.g., the chain may contain an ether group).

The polymer composition can be made using any technique, provided that the polymer composition does not contain substantial amounts of anything that interferes with the antimicrobial properties of the antimicrobial polymer composition. For instance, polytrimethylene terephthalates can be manufactured by any process known in the art. Polytrimethylene terephthalates useful as the polymer composition are commercially available from E.I. du Pont de Nemours & Company, Wilmington, Del., under the trademark Sorona®.

The preferred number average molecular weight (“Mₙ”) depends on the polymer composition used. The Mₙ for polyethers is preferably in a range of from about 300 to about 2,000. The Mₙ for polycarbonates is preferably in a range of from about 500 to about 2,000. The Mₙ for polyolefins is preferably in a range of from about 30,000 to about 45,000. In a preferred embodiment, the Mₙ for polyalkylene terephthalates is preferably at least about 15,000, more preferably at least about 18,000, and is preferably about 40,000 or less, more preferably about 35,000 or less. When polyethylene terephthalate is the polyalkylene terephthalate, the Mₙ is even more preferably in a range of from about 15,000 to about 25,000, with an Mₙ of about 25,000 most preferred. When polytetramethylene terephthalate is the polyalkylene terephthalate, the Mₙ is even more preferably in a range of from about 25,000 to about 35,000, with an Mₙ of about 27,000 most preferred. When polytrimethylene terephthalate is the polyalkylene terephthalate, the Mₙ is even more preferably in a range of from about 25,000 to about 35,000, with an Mₙ range of from about 28,000 to about 29,000 most preferred.

The polymeric additive is prepared as described in commonly assigned U.S. Pat. No. 6,723,799. Preferably the polymeric additive containing secondary amine units is prepared by polymerizing a dicarboxylic acid and a polyamine containing secondary amine units. Preferably the polymeric additive containing a tertiary amine unit is prepared by polymerizing a dicarboxylic acid and a polyamine containing secondary amine units, and then alkylating the secondary amine units in the resulting polyamide to form a polyamide containing the corresponding tertiary amine units. More preferably, the above alkylation is performed by methylation under acidic conditions, using formaldehyde and formic acid. Alternatively, the tertiary polymeric additive may be prepared by polymerizing a polyamine containing tertiary amine units or its salts and one or more other monomer or polymer units.

More preferably the polymeric additive is prepared by polymerizing (i) polyamine containing secondary or tertiary amine unit(s) or salts thereof and (ii) other monomer units, wherein the polyamine is selected from those having the formula:
H₂N(CH₂)ₘ[NR(CH₂)ₙ]ₐNH₂
wherein m and n, which can be the same or different, are integers of 4 to 10, a is 1 to 2, and R is hydrogen or an alkyl group containing 1 to about 4 carbons in a straight or branched chain. More preferably, the polyamine is selected from methyl-bis(hexamethylene) triamine, methyl-bis(hexamethylene)tetramine, methyl-bis(tetramethylene)triamine, and dimethyl-bis(tetramethylene)tetramine, or salts thereof. Preferably the polyamine unit is combined with an adipate, terephthalate, isophthalate, or naphthalate unit.

Preferably the polymeric additive is poly(6,6′-alkylimino-bishexamethylene adipamide), poly(6,6′-alkylimino-bistetramethylene adipamide), poly(N,N′-dialkylimino-tri(tetramethylene)) adipamide, or mixtures thereof, wherein the alkyl group has 1 to about 4 carbon atoms.

The Mₙ of the polymeric additive (before reaction with polymer units) is preferably at least about 1,000, more preferably at least about 3,000, and most preferably at least about 4,000, and preferably about 10,000 or less, more preferably about 7,000 or less, and most preferably about 5,000 or less. The preferred Mₙ depends on the polymeric additive used, the balance of the composition, and the desired properties.

The above polymeric additive(s) are disclosed in part in commonly assigned U.S. Pat. No. 6,576,340, and in part in commonly assigned U.S. Pat. No. 6,723,799, wherein they were found to be effective in manufacturing acid-dyeable polyester and nylon compositions. Surprisingly, these polymeric additives promote antimicrobial properties in these compositions. Additionally, when polytrimethylene terephthalate fabrics containing these additives were dyed with acid dyes, the fabrics were found to have lost their antimicrobial properties. The acid dyeing occurs at the site of the polymeric additive, i.e., the acid dye molecule binds to nitrogen groups of the polymeric additive. Thus, the polymeric additives, as used herein, should not be acid-dyed, nor should they be subjected to any equivalent altering steps that would irreversibly tie up their amine sites. In this way, some or all of the original nitrogen groups remain available for interaction with negatively charged functionalities.

However, other dyeing techniques, well known to those of ordinary skill in the art, can be used. For example, articles comprising the polymeric additive can be pigment dyed in a way that does not tie up the amine sites of the polymers. The pigment dyes may be added before or after spinning the fibers or extruding the films, providing the dyeing method meets the above criteria.

Preferably the polymeric additive is incorporated into the polymer composition by melt blending. The temperature should be above the melting points of each component but below the lowest decomposition temperature, and accordingly must be adjusted for any particular composition of polymer composition and polymeric additive. The polymer composition and polymeric additive may be heated and mixed simultaneously, pre-mixed in a separate apparatus before the heating occurs, or alternately may be heated separately and then mixed. Further, the polymer composition may be formed and then used, or may be formed during use (e.g., by mixing and heating chips or flakes of polymer composition and polymeric additive in an extruder at a fiber or film manufacturing facility, or by blending molten polymer composition and polymeric additive in fiber or film manufacture). Melt blending is preferably carried out at about 200 to about 295° C., more preferably about 260 to about 285° C., depending on the polymer composition. For polytrimethylene terephthalate, the preferred temperatures are about 230 to about 270° C., more preferably about 260° C. For polyethylene terephthalate, the preferred temperatures are about 200 to about 295° C., more preferably about 280 to about 290° C. For polybutylene terephthalate, the preferred temperatures are about 200 to about 295° C., more preferably about 250 to about 275° C.

The polymer composition and the polymeric additive can react. Because the antimicrobial composition comprises more polymer composition than polymeric additive, the antimicrobial polymer composition comprises polymeric additive comprising polymer composition and polymeric additive repeat units and unreacted polymer composition. In many instances, the antimicrobial polymer composition will contain polymeric additive that has no units from the polymer composition. In a preferred embodiment, the antimicrobial polymer composition comprises a block copolymer of polyester and the polymeric additive. By block copolymer, for example with reference to the poly(6,6′-alkylimino-bishexamethylene adipamide) polymeric additive and polytrimethylene terephthalate, is meant a random copolymer formed by the polyester joined to the polymeric additive by a covalent bond.

The antimicrobial polymer composition can further comprise unreacted polymer composition and polymeric additive.

Preferably, incorporating an effective amount of polymeric additive into the polymer composition results in at least about a 2-log reduction in microorganism density after 24 hours on test material compared to a control material without the polymeric additive. More preferably, an effective amount of polymeric additive results in at least about a 3-log reduction, and even more preferably a 4-log reduction.

In one embodiment, incorporating an effective amount of polymeric additive into the polymer composition results in an antimicrobial polymer composition having about 0.1 to about 20 mol %, more preferably about 0.5 to about 10 mol %, even more preferably about 1 to about 5 mol %, and even more preferably still about 2 to about 4 mol % of secondary or tertiary amine units, based on the number of repeat units in the antimicrobial polymer composition including the polymer composition and the polymeric additive. In an alternate embodiment, incorporating an effective amount of polymeric additive into the polymer composition results in an antimicrobial polymer composition having about 0.1 to about 15 mol %, more preferably about 0.5 to about 7 mol %, even more preferably about 0.7 to about 2 mol % of secondary or tertiary amine units, based on the number of repeat units in the antimicrobial polymer composition including the polymer composition and the polymeric additive.

The polyester or nylon composition of the invention may be used to produce, antimicrobial shaped articles, including high strength shaped articles. For example, in particular embodiments of the invention wherein the polyester is polytrimethylene terephthalate, melt-spun filaments having a tenacity of 2.0 g/d or more and a dye exhaustion of 30%-90% or higher, preferably 60%-95% or higher, are obtained. This is quite remarkable because polytrimethylene terephthalate is generally considered a difficult polyester to spin into high strength fibers or filaments. An added difficulty is that the use of additives to enhance one property of a polymer, e.g., antimicrobial properties, often negatively affects other properties such as processability and strength. However, in accordance with the invention, antimicrobial, high strength polyalkylene terephthalates, for example poly(trimethylene) terephthalate, fibers are obtained.

The antimicrobial polymer composition can further comprise known additives to improve strength or facilitate post-extrusion processing. For example, hexamethylene diamine and/or polyamides such as nylon 6 or nylon 6,6 may be added in minor amounts (e.g., from about 0.5 to about 5 mol %) to add strength and processability. The antimicrobial polymer composition can, if desired, contain various other additives, e.g., antioxidants, delusterants (e.g., TiO₂, zinc sulfide, or zinc oxide), colorants (e.g., dyes or pigments), stabilizers, flame retardants, fillers (such as calcium carbonate), additional antimicrobial agents, antistatic agents, optical brighteners, extenders, processing aids, viscosity boosters, toning pigments, and other functional additives. TiO₂ may be added to the polymer or fibers.

The compositions of this invention are useful in fibers, fabrics, films and other useful articles, and methods of making such compositions and articles. By “fibers”, reference is made to items recognized in the art as fibers, such as continuous filaments, staple, and other chopped fibers. The fibers may be monocomponent (sometimes also referred to as “homofibers”), or bicomponent or other multicomponent fibers, including sheath-core, eccentric sheath-core, and side-by-side fibers, and yarns made therefrom. Fabrics include knitted, woven and nonwoven fabrics. The compositions may form a film or a film layer, etc.

Bulked continuous filaments and fabrics may be manufactured according to the process described in U.S. Pat. Nos. 5,645,782 and 5,662,980. Other documents describing fibers and fabrics, and their manufacture, include U.S. Pat. Nos. 5,885,909 and 5,782,935, WO 99/06399, 99/27168, 99/39041, 00/22210, 00/26301, 00/29653, 00/29654, 00/39374 and 00/47507, EP 745 711, 1 016 741, 1 016 692, 1 006 220 and 1 033 422, British Patent Specification No.1 254 826, JP 11-100721, 11-107036,11-107038, 11-107081, 11-189920, and 11-189938, U.S. patent application Ser. Nos. 09/518,732 and 09/518,759, and H. L. Traub, “Synthese und textilchemische Eigenschaften des Poly-Trimethyleneterephthalats”, Dissertation Universitat Stuttgart (1994), H. L. Traub “Dyeing properties of Poly(trimethylene terephthalate) fibres”, Melliand (1995), H. L. Traub et al., “Mechanical Properties of fibers made of polytrimethylene terephthalate”, Chemical Fibers International (CFI) Vol. 45,110-111 (1995), W. Oppermann et al. “Fibers Made of Poly(trimethylene terephthalate)”, Dornbirn (1995), H. S. Brown, H. H. Chuah, “Texturing of Textile Filament Yarns Based on Poly(trimethylene terephthalate)”, Chemical Fibers International, 47:1, 1997. pp. 72-74, Schauhoff, S. “New Developments in the Production of Polytrimethylene Terephthalate (PTT)”, Man-Made Fiber Year Book (September 1996).

The antimicrobial polymer compositions can be used to make antimicrobial polymer bicomponent fibers, for example, bicomponent fibers comprising poly(ethylene terephthalate) and poly(trimethylene terephthalate) or poly(ethylene terephthalate) and poly(tetramethylene terephthalate). Bicomponent fibers based on poly(ethylene terephthalate) and poly(trimethylene terephthalate) are preferred. T he polymeric additive can be incorporated into either or both components. The components can be arranged in a sheath-core, eccentric sheath-core, or side-by-side relationship. When it is desired that the bicomponent fiber be crimpable on drawing, heat-treating, and relaxing to form a stretchable fiber, an eccentric sheath-core or side-by-side relationship can be used; side-by-side is preferred for higher crimp levels. The preferred polyethylene terephthalate/polytrimethylene terephthalate bicomponent fibers can be manufactured as described in U.S. Pat. No. 6,692,687. One or both of the polyesters used in these bicomponent fibers can be copolyesters. Comonomers useful in such copolyesters are described previously. The comonomer can be present in the copolyester at a level in the range of about 0.5 to 15 mole percent.

### EXAMPLES

The present invention is further defined in the following Examples. It should be understood that these Examples, while indicating preferred embodiments of the invention, are given by way of illustration only. From the above discussion and these Examples, one skilled in the art can ascertain the preferred features of this invention, and without departing from the spirit and scope thereof, can make various changes and modifications of the invention to adapt it to various uses and conditions.

The meaning of abbreviations is as follows: “h” means hour(s), “mL” means milliliter(s), “mg” means milligram(s), “wt %” means weight percent(age), “Me-BHMT” means methyl-bis(hexamethylene) triamine, “Me-BHMT-TAM” means methyl-bis(hexamethylene) tetramine, “3GT” means polytrimethylene terephthalate, “2GT” means polyethylene terephthalate, “CFU” means colony forming unit(s), “AATCC” means American Association of Textile Chemists and Colorists, “ATCC” means American Type Culture Collection, and “PE” means polyethylene.

### General Experimental Procedures

The antimicrobial activity of a specimen was tested using a method developed for immobilized and slowly diffusing antimicrobial agents. It ensures good contact between the microorganisms and the test specimen by constant agitation of the test specimen in a buffer during the test period. The test bacteria were Staphylococcus aureus (ATCC No. 6538), a Gram (+) bacterium, and Klebsiella pneumoniae (ATCC No. 4352), a Gram (−) bacterium. The bacteria, suspended in 75 mL of phosphate buffer, were shaken with 25-750 mg of sample on a wrist-action shaker. All enumerations were performed by plating on Trypticase Soy Agar (TSA, BBL) plates after 24 h and incubating the plates at 35° C. Dacron® 2GT fibers containing the antimicrobial agent Dow Corning-5700 (“DC-5700”) were used as the positive control. Untreated Dacron® fibers served as the negative control. Dacron® 2GT is available from E.I. du Pont de Nemours & Co. (Wilmington, Del.). Duplicate samples and controls were evaluated to determine the variability in testing.

For hard surface tests (for films or shaped polymeric items), tiles of the test material were inoculated with a known density of microorganism(s) and incubated at high humidity to retard drying. Following standard microbiological techniques for enumerating microorganisms, significant efficacy was demonstrated when, for example, a 3-log reduction in density on test material compared to a control material without the antimicrobial agent was demonstrated. This level of efficacy has been identified by the U.S. Environmental Protection Agency (“EPA”) as having “antibacterial hard surface” activity. The test bacteria were Staphylococcus aureus (ATCC No. 6538) and Escherichia coli (ATCC No. 25922).

To test the fungicidal activity of fibers, duplicate control samples were evaluated to determine the variability in testing. The test fungus was Aspergillus niger (ATCC No. 6275). The fungi, suspended in 2 mL of phosphate buffer, were shaken with 20 mg samples on a VWR orbital shaker. Enumerations were performed by plating on Trypticase Soy Agar (TSA, BBL) plates after <48 h incubation at 30° C. Dacron® fibers containing DC-5700 were used as the positive control. Untreated Dacron® fibers served as the negative control.

The antimicrobial activity of a specimen is reported using kₜ, the death rate constant, and Δt, the activity constant, where t is the contact time. The death rate constant kₜ is a measure of the antimicrobial activity based upon the exponential reduction of a starting microbial population. The activity constant Δt is a measure of the antimicrobial activity of a treated specimen relative to a control specimen.

The value of “Δt” is calculated to the nearest tenth as follows:
Δt =activity constant for contact time t=C−B
C=the mean log₁₀ density of microbes in flasks of untreated control specimen after X hours incubation (preferably X=24)
B=the mean log₁₀ density of microbes in flasks of test item after X hours incubation (preferably X=24)

Forming Units of bacteria, the level of antimicrobial activity, is expressed as the Δt value where, Δt=log CFU/mL of the Inoculated Control−log CFU/mL of the Test Sample (both at the same exposure time).

The “Δt” values are equivalent to the values listed in Table 1.

TABLE 1
Summary of the Meaning of “Δt” Values

| Δt | % Reduction of Bacteria |
|---|---|
| <0.0 | 0 |
| 0.1-1.0 | 10-90 |
| 1.1-2.0 | 91-99 |
| ≧2.1 | >99 |

The fibers of the following examples were prepared following the methods disclosed in U.S. Pat. No. 6,576,340 and U.S. Pat. No. 6,723,799 except where so noted.

### Example 1

3GT copolymer was prepared using 4 mol % tertiary amine (Me-BHMT; based on the total moles of polymer repeating units including the repeating units of polymeric additive) in the polymeric composition (a detailed description of the polymer preparation, compounding, and spinning can be found in U.S. Pat. No. 6,723,799). The copolymer was melt extruded, and the pellets were dried and spun into fibers. The antibacterial test results on the 3GT fiber containing 4 mol % Me-BHMT and the test results on the control fiber are shown in Table 2. Samples were tested against a positive Dacron® control using a well-known, leachable antibacterial agent (DC-5700) and against a negative control without antibacterial agent and without Me-BHMT additive. The limit of detection for this method for all tables is a minimum of 10 CFU/mL.

TABLE 2
Antimicrobial properties of polyester fibers with Gram (−)
and Gram (+) bacteria

| Samples | Microorganism | 24 h CFU/mL | 24 h Δt |
|---|---|---|---|
| Example 1 | Klebsiella pneumoniae | <10 | 4.1 |
| Example 1 | Staphylococcus aureus | <10 | 4.3 |
| Control 3GT | Klebsiella pneumoniae | 3.1 × 10⁵ | 0.2 |
| Control 3GT | Staphylococcus aureus | 4.1 × 10⁴ | 0.5 |
| Treated Dacron ® | Klebsiella pneumoniae | <10 | 4.1 |
| Control (DC- | | | |
| 5700) | | | |
| Treated Dacron ® | Staphylococcus aureus | <10 | 4.3 |
| Control (DC- | | | |
| 5700) | | | |

The antibacterial properties of the 3GT fiber containing 4.0 mol % Me-BHMT were excellent (4-log reduction in Δt). Results were essentially equal to the sample treated with a leachable antibacterial agent (the positive Dacron® control). The untreated control sample of 3GT had no antibacterial activity.

### Example 2

3GT copolymer was prepared using 2 mol % Me-BHMT in the polymeric composition. The polymer was pelletized, and the pellets were spun with 2GT and 3GT into bicomponent fibers (a description of the polymer preparation, compounding, and spinning can be found in U.S. Pat. No. 6,692,687). The control 2GT/3GT bicomponent fibers were obtained in the same manner. The results are shown in Table 3.

TABLE 3
Antibacterial efficiency results on the bicomponent fibers

| Samples | Microorganism | Mean CFU/mL | 24 h Δt |
|---|---|---|---|
| Example 2 | Klebsiella pneumoniae | <10 | 4.6 |
| Example 2 | Staphylococcus aureus | <10 | 4.3 |
| Control | Klebsiella pneumoniae | 8.4 × 10⁵ | −0.3 |
| bicomponent | | | |
| Control | Staphylococcus aureus | 1.8 × 10⁵ | 0.0 |
| bicomponent | | | |
| Treated | Klebsiella pneumoniae | <10 | 4.6 |
| Dacron ® | | | |
| control | | | |
| Treated | Staphylococcus aureus | <10 | 4.3 |
| Dacron ® | | | |
| control | | | |

The antibacterial properties of the 2GT/3GT fiber containing 2.0 mol % Me-BHMT (4-log reduction in Δt) was the same as the positive Dacron® control (treated with antibacterial agent). Control bicomponent fibers had no antibacterial activity.

### Example 3

3GT copolymer was prepared using 2 mol % Me-BHMT-TAM (a detailed description of the polymer preparation, compounding, and spinning can be found in U.S. Pat. No. 6,723,799). The copolymer was melt extruded and the pellets were spun into fibers. The control 3GT fibers were prepared on the same manner. The results are shown in Table 4.

TABLE 4
Antibacterial efficiency results on the fibers

| Samples | Microorganism | Mean CFU/mL | 24 h Δt |
|---|---|---|---|
| Example 3 | Klebsiella pneumoniae | <10 | 4.7 |
| Example 3 | Staphylococcus aureus | <10 | 4.1 |
| Control 3GT | Klebsiella pneumoniae | 3.1 × 10⁵ | 0.2 |
| Control 3GT | Staphylococcus aureus | 4.1 × 10⁴ | 0.5 |
| Treated | Klebsiella pneumoniae | <10 | 4.7 |
| Dacron ® | | | |
| control | | | |
| Treated | Staphylococcus aureus | <10 | 4.1 |
| Dacron ® | | | |
| control | | | |

Example 3 fibers had the same antibacterial activity as the treated Dacron® control. The control 3GT fibers had no activity.

### Example 4A

3GT copolymer fibers were prepared using 4 mol % Me-BHMT as in Example 1. Standard washing cycles were performed on the fibers (AATCC, 4 cycle, equivalent to 20 residential wash cycles). Control 3GT fibers were prepared as in Example 1. The results are shown in Table 5.

### Example 4B

Tests were carried out as in Example 4A except that the washing cycle was AATCC, 6 cycle; equivalent to 30 residential wash cycles. The results are shown in Table 5.

TABLE 5
Antibacterial tests after 4 and 6 economic wash cycles

| Samples | Microorganism | Mean CFU/mL | 24 h Δt |
|---|---|---|---|
| Example 4A | Klebsiella pneumoniae | <10 | 4.6 |
| Example 4A | Staphylococcus aureus | <10 | 3.0 |
| Example 4B | Klebsiella pneumoniae | 3.0 × 10² | 4.6 |
| Example 4B | Staphylococcus aureus | 2.0 × 10² | 2.8 |
| Control 3GT | Klebsiella pneumoniae | 3.1 × 10⁵ | 0.2 |
| Control 3GT | Staphylococcus aureus | 4.1 × 10⁴ | 0.5 |
| Treated | Klebsiella pneumoniae | <10 | 4.6 |
| Dacron ® control | | | |
| Treated | Staphylococcus aureus | <10 | 4.3 |
| Dacron ® control | | | |

As shown in Table 5, 3GT fibers prepared with Me-BHMT polymer had the same antibacterial properties as the treated Dacron® control fibers after 4 economic wash cycles (4-log reduction). After 6 economic wash cycles, the 3GT fibers prepared with Me-BHMT polymer showed a 3-log reduction. The control 3GT fibers had no activity.

### Example 5A

Polymeric films were prepared by a twin-screw extruder (in 2 mil, 4 mil, and 6 mil thickness) using 3GT/2 mol % Me-BHMT copolymer (a detailed description of the polymer preparation and compounding can be found in U.S. Pat. No. 6,723,799). The sample with 2 mil thickness was used for test. Standard antibacterial tests were performed on the samples. A 3-log reduction in density on test material compared to a control material without the antimicrobial agent demonstrates significant efficacy. The test bacteria were Staphylococcus aureus (ATCC No. 6538). The results are shown in Table 6.

### Example 5B

Polymeric films were prepared as in Example 5A except that 3GT/4 mol % Me-BHMT copolymer was used. The results are shown in Table 6.

### Example 5C

Polymeric films were prepared as in Example 5A except that 3GT/1 mol % Me-BHMT-TAM copolymer was used. The results are shown in Table 6.

TABLE 6
Antibacterial test results on the polymeric film samples

| Samples | Microorganism | Mean CFU/mL | 24 h Δt |
|---|---|---|---|
| Example 5A | Staphylococcus aureus | <10 | 4.5 |
| Example 5B | Staphylococcus aureus | <10 | 4.5 |
| Example 5C | Staphylococcus aureus | <10 | 4.6 |
| Control 3GT | Staphylococcus aureus | 3.8 × 10⁵ | −0.1 |
| Treated | Staphylococcus aureus | <10 | 4.5 |
| Dacron ® control | | | |

Examples 5A, 5B, and 5C had the same antimicrobial efficacy as the treated Dacron® control (4-log reduction). The control 3GT film had no activity.

### Example 6A

Polymeric shaped items were prepared by press molding (hard polymeric disks) using 3GT/2 mol % Me-BHMT copolymer (a detailed description of the polymer preparation and compounding can be found in U.S. Pat. No. 6,723,799). 3GT control sample was prepared in the same way. Standard antibacterial tests were performed on the samples. The test bacteria were Escherichia coli (ATCC No. 25922). The results are shown in Table 7.

### Example 6B

Polymeric shaped items (hard polymeric disks) using 3GT/4 mol % Me-BHMT copolymer as in Example 6A. 3GT control sample was prepared in the same way. Standard antibacterial tests were performed on the samples. The results are shown in Table 7.

### Example 6C

Polymeric shaped items (hard polymeric disks) using 3GT/1 mol % Me-BHMT-TAM copolymer as in Example 6A. 3GT control sample was prepared in the same way. Standard antibacterial tests were performed on the samples. The results are shown in Table 7.

TABLE 7
Antibacterial test results on the polymeric shaped items

| Samples | Microorganism | Mean CFU/mL | 24 h Δt |
|---|---|---|---|
| Example 6A | Escherichia coli | <10 | 3.5 |
| Example 6B | Escherichia coli | <10 | 3.5 |
| Example 6C | Escherichia coli | <10 | 3.6 |
| Control 3GT | Escherichia coli | 3.3 × 10⁴ | 0.0 |

Examples 6A, 6B, and 6C demonstrated (3-log reduction) antibacterial activity. The control 3GT item had no activity.

### Example 7A

Non-woven fibers were prepared using a typical industrial procedure in which polymers are dissolved in a solvent in an enclosed vessel using temperature and pressure to keep the polymer in solution. At a designated temperature (high enough so that the solvent will vaporize at room temperature), the pressure is dropped so that the polymer just begins to come out of solution (the cloud point). The exit of a spinneret orifice is then unplugged, and the solvent rapidly forces the polymer out to atmospheric conditions within the hood. The solvent immediately “flashes” to vapor and is carried up the exhaust, while the polymer is stretched during the rapid expulsion and solidifies into long intertwined fibers (a detailed description of the method can be found in U.S. Pat. No. 6,458,304 issued to Shin et al. on Oct. 1, 2002).

In this example, non-woven fibers were prepared using 85 wt % of PE and 15 wt % of 3GT/4 mol % Me-BHMT copolymer. PE control fibers were prepared in the same way. Results are shown in Table 8.

### Example 7B

Non-woven fibers were prepared using 80 wt % of PE and 20 wt % of 3GT/4 mol % Me-BHMT copolymer. PE control fibers were prepared in the same way. Results are shown in Table 8.

### Example 7C

Non-woven fibers were prepared using 70 wt % of PE and 30 wt % of 3GT/4 mol % Me-BHMT copolymer. PE control fibers were prepared in the same way. Results are shown in Table 8.

### Example 7D

Non-woven fibers were prepared using 50 wt % of PE and 50 wt % of 3GT/4 mol % Me-BHMT copolymer. PE control fibers were prepared in the same way. Results are shown in Table 8.

TABLE 8
Antibacterial test results on the non-woven fibers

| Samples | Microorganism | Mean CFU/mL | 24 h Δt |
|---|---|---|---|
| Example 7A | Staphylococcus aureus | <10 | 3.9 |
| Example 7A | Klbsiella pneumoniae | <10 | 5.5 |
| Example 7B | Staphylococcus aureus | <10 | 3.9 |
| Example 7B | Klebsiella pneumoniae | <10 | 5.5 |
| Example 7C | Staphylococcus aureus | <10 | 3.9 |
| Example 7C | Klebsiella pneumoniae | <10 | 5.5 |
| Example 7D | Staphylococcus aureus | <10 | 3.9 |
| Example 7D | Klebsiella pneumoniae | <10 | 5.5 |
| Treated | Staphylococcus aureus | <10 | 3.9 |
| Dacron ® control | | | |
| Treated | Klebsiella pneumoniae | <10 | 5.5 |
| Dacron ® control | | | |
| PE control | Staphylococcus aureus | 3.1 × 10⁴ | 0.4 |
| PE control | Klebsiella pneumoniae | 3.0 × 10⁶ | 0.1 |
| Control 3GT | Klebsiella pneumoniae | 3.1 × 10⁵ | 0.2 |
| Control 3GT | Staphylococcus aureus | 4.1 × 10⁴ | 0.5 |

Each composition of the non-woven fibers showed excellent antibacterial properties against Gram (+) and Gram (−) bacteria. Examples 7A, 7B, 7C, and 7D had the same efficacy as the treated Dacron® control. The PE and 3GT control fibers did not demonstrate antibacterial activity.

### Example 8A

Non-woven fibers were prepared using 85 wt % of PE and 15 wt % of 3GT/4 mol % Me-BHMT copolymer. PE control fibers were prepared in the same way. The samples were tested for antifungal efficacy. Results are shown in Table 9.

### Example 8B

Non-woven fibers were prepared using 80 wt % of PE and 20 wt % of 3GT/4 mol % Me-BHMT copolymer. PE control fibers were prepared in the same way. The samples were tested for antifungal efficacy. Results are shown in Table 9.

### Example 8C

Non-woven fibers were prepared using 70 wt % of PE and 30 wt % of 3GT/4 mol % Me-BHMT copolymer. PE control fibers were prepared in the same way. The samples were tested for antifungal efficacy. Results are shown in Table 9.

### Example 8D

Non-woven fibers were prepared using 50 wt % of PE and 50 wt % of 3GT/4 mol % Me-BHMT copolymer. PE control fibers were prepared in the same way. The samples were tested for antifungal efficacy. Results are shown in Table 9.

### Example 8E

3GT copolymer was prepared using 4 mol % tertiary amine (Me-BHMT; based on the total moles of polymer repeating units including the repeating units of polymeric additive) in the polymeric composition. The copolymer was melt extruded and the pellets were dried and spun into fibers. The samples were tested for antifungal efficacy. Results are shown in Table 9.

TABLE 9
Antifungal test results on the non-woven fibers

| Samples | Microorganism | Mean CFU/mL | 24 h Δt |
|---|---|---|---|
| Example 8A | Aspergillus niger | 3.1 × 10³ | 1.2 |
| Example 8B | Aspergillus niger | 1.3 × 10³ | 1.6 |
| Example 8C | Aspergillus niger | 7.3 × 10³ | 0.8 |
| Example 8D | Aspergillus niger | 9.8 × 10² | 1.7 |
| Example 8E | Aspergillus niger | 7.5 × 10² | 1.8 |
| Treated | Aspergillus niger | 5.8 × 10¹ | 3.0 |
| Dacron ® | | | |
| control | | | |
| PE control | Aspergillus niger | 1.9 × 10⁴ | 0.4 |
| Control 3GT | Aspergillus niger | 1.0 × 10⁵ | −0.3 |

Example 8D and Example 8E showed a 2-log reduction compared to treated Dacron® control. Examples 8A, 8B, and 8C, containing lower amounts of the 3GT/4 mol % Me-BHMT copolymer, were only marginally effective. The PE and control 3GT fibers did not demonstrate antifungal activity.

1.-11. (canceled)

12. An article comprising an antimicrobial polymer composition comprising
a) at least one polyester, at least one polyether, at least one polycarbonate, at least one polyolefin, or combinations thereof: and
b) about 0.1 to less than 2.0 mol % of a polymeric additive comprising repeating units having the formula 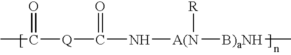
or salts thereof, wherein A, B, and Q, independently, are aliphatic or aromatic substituents provided that at least four carbon atoms separate any two nitrogen groups, R is an aliphatic or aromatic group or hydrogen, a is 1 to about 5, and n is 3 to about 10,000; and wherein the nitrogen mol groups remain available for interaction with negatively charged functionalities.

13. The article of claim 12 in the form of fiber, fabric, yarn, membrane, film, or film layer.

14. The article of claim 13, wherein the fiber is in the form of monocomponent fiber or bicomponent fiber.

15. The article of claim 14, wherein the bicomponent fiber comprises polyethylene terephthalate and polytrimethylene terephthalate.

16. The article of claim 13, wherein the fiber, fabric, yam, membrane, film, or film layer is formed by extrusion.

17. The article of claim 16, wherein the polymeric additive is incorporated into the polymer composition prior to extrusion.

18. The article of claim 12, wherein said article is pigment dyed.

19. A garment of non-woven fabric comprising a polymer composition comprising
a) at least one polyester, at least one polyether, at least one polycarbonate, at least one polyolefin, or combinations thereof; and
b) about 0.1 to less than 2.0 mol % of a polymeric additive comprising repeating units having the formula 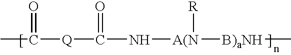
or salts thereof, wherein A, B, and Q, independently, are aliphatic or aromatic substituents provided that at least four carbon atoms separate any two nitrogen groups, R is an aliphatic or aromatic group or hydrogen, a is 1 to about 5, and n is 3 to about 10,000: and wherein the nitrogen groups remain available for interaction with negatively charged functionalities.

20.-22. (canceled)

23. A process for producing an antimicrobial polymer composition, comprising
incorporating into a polymer composition comprising at least one polyester, at least one polyether, at least one polycarbonate, at least one polyolefin, or combinations thereof an effective amount of polymeric additive comprising repeating units having the formula 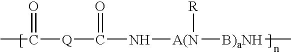
or salts thereof,
wherein A, B, and Q, independently, are aliphatic or aromatic substituents provided that at least four carbon atoms separate any two nitrogen groups, R Is an aliphatic or aromatic group or hydrogen, a is 1 to 5, and n is 3 to 10,000, and wherein the nitrogen groups remain available for interaction with negatively charged functionalities.

24. The process of claim 23, wherein the incorporating step is accomplished by forming a block copolymer of at least one polyester and at least one polymeric additive.

25. The process of claim 24, wherein the at least one polyester is polytrimethylene terephthalate.

26. The process of claim 24, wherein the at least one polymeric additive is poly(6,6′-alkylimino-bishexamethylene adipamide), wherein the alkyl group has 1 to 4 carbon atoms.

27. The process of claim 23, wherein the incorporating step is accomplished by melt blending the polymer composition with the polymeric additive.

28. (canceled)

29. A process for the inhibition of microorganism growth in or on an article, comprising incorporating into or onto the article an antimicrobial polymer composition comprising:
a) a polymer composition comprising at least one polyester, at least one polyether, at least one polycarbonate, at least one polyolefin, or combinations thereof; and
b) an effective amount of polymeric additive comprising repeating units having the formula 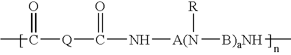
or salts thereof, wherein A, B, and Q, independently, are aliphatic or aromatic substituents provided that at least four carbon atoms separate any two nitrogen groups, R is an aliphatic or aromatic group or hydrogen, a is 1 to 5, and n is 3 to 10,000, and wherein the nitrogen groups remain available for interaction with negatively charged functionalities.

30. The process of claim 29, wherein the microorganisms are bacteria.

31. The process of claim 30, wherein the bacteria are Gram-positive bacteria or Gram-negative bacteria.

32. The process of claim 29, wherein the microorganisms are fungi.

33. A process for producing a dyed article comprising:
(a) providing an article;
(b) incorporating Into the article an antimicrobial polymer composition comprising
at least one polyester, at least one polyether, at least one polycarbonate, at least one polyolefin, or combinations thereof; and
b) about 0.1 to less than 2.0 mol % of a polymeric additive comprising repeating units having the formula 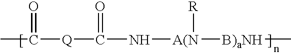
or salts thereof, wherein A, B, and Q, independently, are aliphatic or aromatic substituents provided that at least four carbon atoms separate any two nitrogen groups, R is an aliphatic or aromatic group or hydrogen, a is 1 to about 5, and n is 3 to about 10,000; and wherein the nitrogen groups remain available for interaction with negatively charged functionalities.

34. A process of protecting against infection comprising wearing non-woven apparel comprising an antimicrobial polymer composition comprising
a) at least one polyester, at least one polyether, at least one polycarbonate, at least one polyolefin, or combinations thereof: and
b) about 0.1 to less than 2.0 mol % of a polymeric additive comprising repeating units having the formula 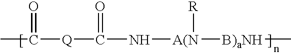
or salts thereof, wherein A, B, and Q, independently, are aliphatic or aromatic substituents provided that at least four carbon atoms separate any two nitrogen groups, R is an aliphatic or aromatic group or hydrogen, a is 1 to about 5, and is 3 to about 10,000; and wherein the nitrogen groups remain available for interaction with negatively charged functionalities.

35. The process of claim 34, wherein the non-woven apparel is a gown.

36. The process of claim 35, wherein the non-woven apparel is worn by a doctor, a nurse, or patient.

37. The process of using a polymer composition as an antimicrobial agent comprising:
(a) making a polymer composition comprising
at least one polyester, at least one polyether, at least one polycarbonate, at least one polyolefin, or combinations thereof; and
an effective amount of polymeric additive comprising repeating units having the formula 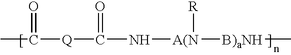
or salts thereof, wherein A, B, and Q, independently, are aliphatic or aromatic substituents provided that at least four carbon atoms separate any two nitrogen groups, R is an aliphatic or aromatic group or hydrogen, a is 1 to 5, and n is 3 to 10,000, and wherein the nitrogen groups remain available for interaction with negatively charged functionalities;
b) Incorporating the polymer composition of (a) into or onto an article.

38. The process of claim 37, wherein the article is selected from the group consisting of a dyed article, a non-woven garment and a gown worn by medical professionals.

39. The process of claim 37, wherein the antimicrobial agent is effective against the microbes selected from the group consisting of bacteria and fungi.

40. The process of claim 37, wherein the incorporating step is accomplished by melt blending the polymer composition with the polymeric additive.

41. The process of claim 37, wherein the incorporating step is accomplished by forming a block copolymer of at least one polyester and at least one polymeric additive and wherein at least one polyester is polytrimethylene terephthalate.
